(19) United States
(12) Patent Application Publication
(10) Pub. No.: US 2008/0162489 A1
(43) Pub. Date: Jul. 3, 2008

(54) APPARATUS AND METHOD FOR EXCHANGING INFORMATION BETWEEN DEVICES

(75) Inventors: Erika Reponen, Tampere (FI); Merja Haveri, Lempaala (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,067

(22) Filed: Dec. 29, 2006

(51) Int. Cl. G06F 17/30

(52) U.S. Cl. 707/10

(57) ABSTRACT

A method including combining at least a portion of one or more pieces of data of at least a first device into a combined data and sending the combined data to at least a second device.

### BACKGROUND

1. Field

The disclosed embodiments relate to communication devices and, more particularly, to exchanging information between devices.

2. Brief Description of Related Developments

Communication devices such as mobile terminals and computers are becoming increasingly commonplace throughout the world. As more and more people begin using these communication devices there is a trend for sending communications through text messaging, email and the like. A user may spend a significant amount of time sending messages to other user to discuss current events about people the user knows or things that are generally occurring throughout the world.

As indicated by the number of tabloid magazines that are published, it is human nature to be curious to what other people are doing whether those other people are friends, enemies, strangers or celebrities. No matter how much is known about a particular person there is always a need to learn more about the person whether it is something in that person's past or a future event that the person doesn't remember, something that the person doesn't want disclosed, or something the person doesn't think is important enough to tell anyone. Presently information about others (e.g. gossip or rumors) is spread through text messages, phone conversations, emails or even through web logs. This information may become distorted as it is passed from one person to the next. This gossip, which is based on events that people have seen or have heard about, may or may not be true and gives individuals a reason to talk to each other.

It would be advantageous to be able to create random stories from events or activities within a communication device and send those stories to other communication devices.

### SUMMARY

In one embodiment, an apparatus is provided. The apparatus includes a data collection unit being configured to collect one or more pieces of data and combine at least a portion of the one or more pieces of data into a combined piece of data and a processor connected to the data collection unit configured to cause a transfer of the combined piece of data to another device.

In one embodiment a method is provided. The method includes combining at least a portion of one or more pieces of data of at least a first device into a combined data and sending the combined data to at least a second device.

In another embodiment a computer program product is provided. The computer program product includes a computer useable medium having computer readable code means embodied therein for causing a computer to combine at least a portion of one or more pieces of data. The computer readable code means in the computer program product includes computer readable program code means for causing a computer to combine a portion of each of the one or more pieces of data of at least a first device into a combined data and computer readable code means for causing a computer to send the combined data to at least a second device.

### BRIEF DESCRIPTION OF THE DRAWINGS

The foregoing aspects and other features of the disclosed embodiments are explained in the following description, taken in connection with the accompanying drawings, wherein:

FIG. 1 shows an exemplary device in which aspects of the described embodiments may be employed;

FIG. 2 is a schematic illustration of an exchange of information in accordance with an embodiment;

FIGS. 3 and 4 are schematic illustrations of an operation of disclosed embodiments;

FIGS. 5-8 show flow diagrams in accordance with the disclosed embodiments;

FIG. 9 shows a device incorporating features of an embodiment;

FIG. 10 shows another device incorporating features of an embodiment;

FIG. 11 is a block diagram illustrating the general architecture of an exemplary mobile devices in which aspects of the disclosed embodiments may be employed;

FIG. 12 is a schematic illustration of a cellular telecommunications system, as an example, of an environment in which a communications device incorporating features of an exemplary embodiment may be applied; and

FIG. 13 illustrates a block diagram of an example of an apparatus incorporating features that may be used to practice aspects of the disclosed embodiments.

### DETAILED DESCRIPTION OF THE EXEMPLARY EMBODIMENT(s)

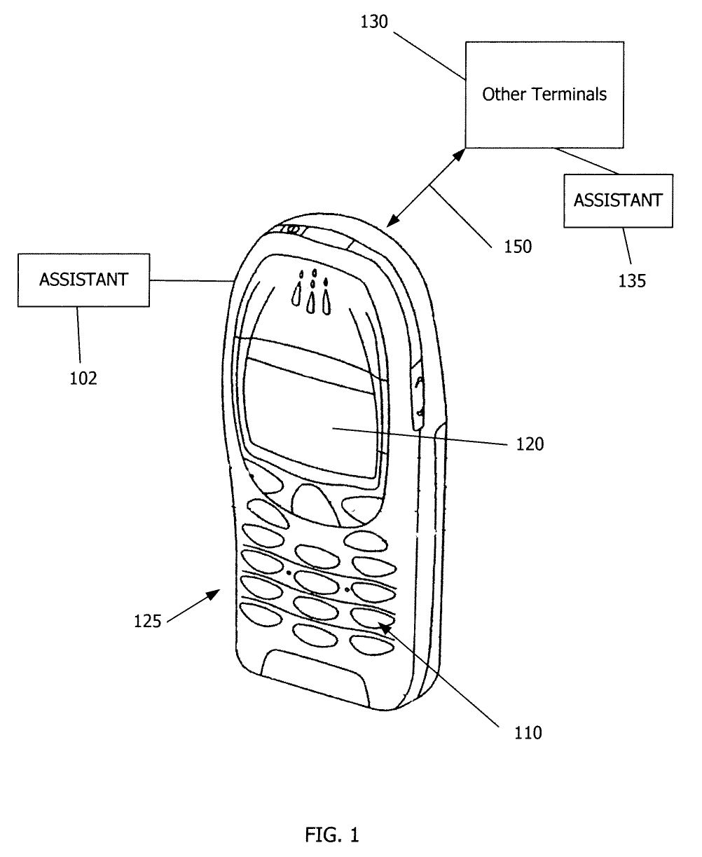

FIG. 1 shows a terminal 125 in which aspects of an embodiment may be employed. Although the embodiments disclosed will be described with reference to the embodiments shown in the drawings, it should be understood that the embodiments disclosed can be embodied in many alternate forms of embodiments. In addition, any suitable size, shape or type of elements or materials could be used.

The terminal 125 may include a keyboard 110, a display 120, and a data collection unit 102 referred to herein as an “assistant”. The terminal may communicate with other terminals 130 over any suitable network 150. The user of the terminal may want to start a rumor or create gossip that will get others talking. The user may want to start a rumor between the user's friends, strangers or any other suitable individual. The rumor may be sent through the terminal 125 via any suitable message to other terminals.

For example, if the user has not spoken with a friend for a while and needs something to talk to that friend about, the user may send a rumor via the communications network 150 to the friend's terminal 130. The friend may read the rumor message and want to contact the user of terminal 125 to discuss the rumor. In other embodiments, the user of the terminal 125 may want to initiate contact with a stranger at, for example a party. The user may send a rumor to that stranger that when read by the stranger would make the stranger want to speak with the user of terminal 125.

In accordance with the disclosed embodiments, the rumor message may be created by, for example, the assistant 102. The assistant 102 may search through and gather information that may be stored in the terminal and combine pieces of information to create a rumor message. The rumor message may or may not be a true and accurate representation of the information from which it was created. The assistant 102 may also combine information from a source external to the terminal 125, such as for example, the internet, another terminal, a peripheral device and the like to create the rumor.

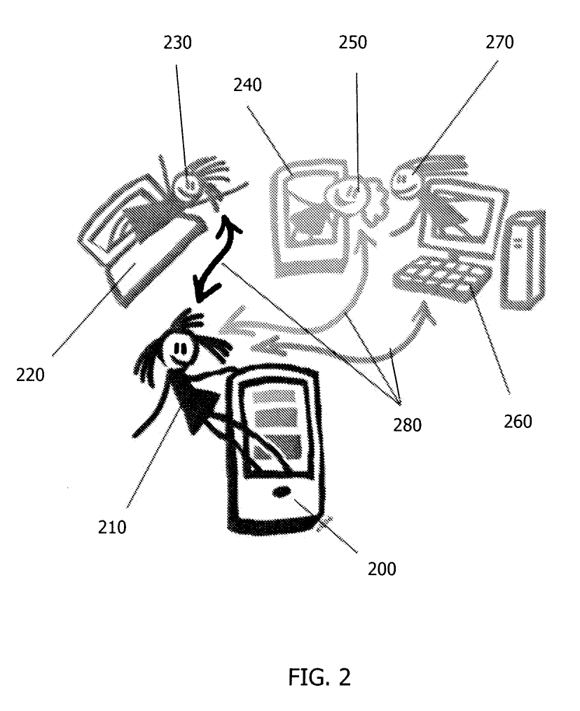

Referring now to FIG. 2 is a schematic illustration of an exchange of information incorporating features of an embodiment is shown. Although four communication devices 200, 220, 240, 260 are shown any number of communication devices may exchange information in accordance with the embodiments described herein. In addition, any suitable combination of devices may exchange information. For example, device 200 may be a mobile terminal such as a mobile phone, device 220 may be a laptop computer, device 240 may be a personal digital assistant (PDA) and device 260 may be a desktop computer. Each of these devices may be capable of sending any suitable type of message to one or more of the other devices. The message may include a written message, a voice message, a video message, a still image or any other suitable message.

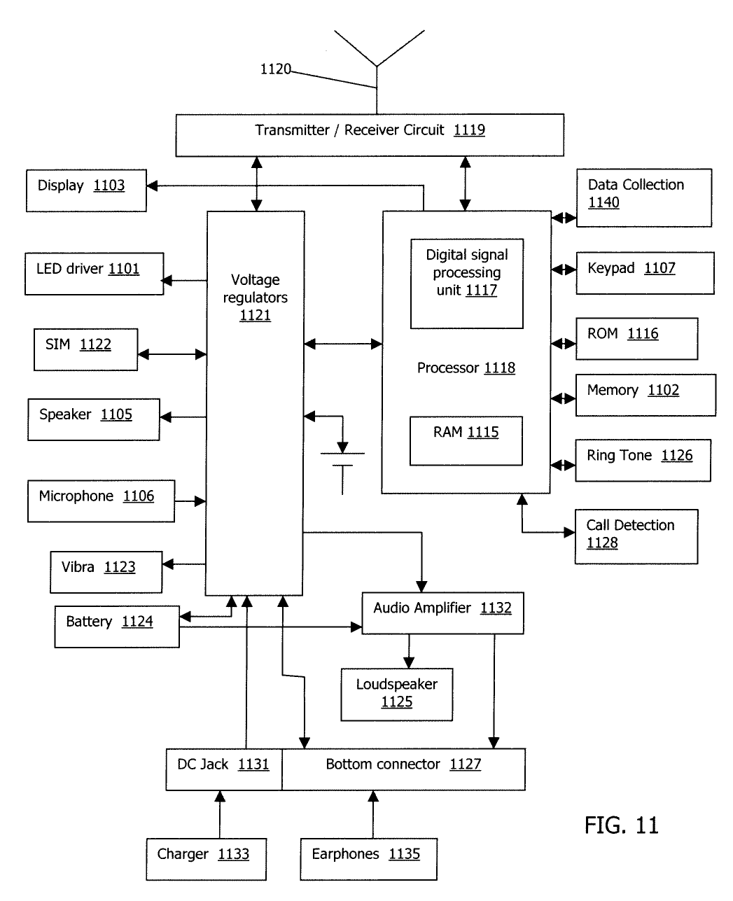

As can be seen in FIG. 2, each of the devices has an assistant 210, 230, 250, 270 for creating rumor messages. The assistant may be software or hardware implemented within each of the devices. For example the assistant may be the data collection unit 1140 shown in FIG. 11. These messages may be created using, for example random information stored within the device or acquired from an outside source. For example, the assistant 210 may search through information corresponding to any suitable application of the device 200 such as, for example, the calendar entries of the device 200. The assistant 210 may randomly select information from the entries and combine the information together. For example, one entry in the calendar of device 200 may read “meet with Joe at the mall” while another calendar entry may read “take the dog to get groomed”. The assistant 210 may randomly select information from each of these entries to create the message “take Joe to the mall to get groomed”. The message may or may not be true and creates a type of gossip or rumor for people to talk about. The assistant may then send the message over a suitable communications network 280 to the assistants 230, 250, 270 in the other devices indicating that the user of device 200 is taking “Joe to the mall to get groomed”. The sending of the message to the other devices may be automatic or user initiated as will be described below in greater detail. In other embodiments one or more of the assistants 230, 250, 270 may send a request to the device 200 for a “rumor” message. The request from the assistants 230, 250, 270 may be user initiated or automatic as will also be discussed below. The user's of the devices 220, 240, 260 may read the rumor message and contact the user of device 200 to discuss the message. As used herein the rumor message is meant to include, but is not limited to text messages, voice messages, email messages, video, images and the like.

The messages sent from the assistants 210, 230, 250, 260 may create a reason for the users of the devices 200, 220, 240, 260 to contact each other. These messages may also provide a certain entertainment value to the users of the devices by occupying a user's spare time or for playing social games.

The assistants 210, 230, 250, 270 may be an application or feature of their respective device 200, 220, 240, 260 that is provided within the device during manufacture of the device or added to the device at a later time. The assistants may communicate with each other through any suitable communications method. For example, communications between assistants may occur over a short range or long range wireless connection such as bluetooth, infrared, wireless local area network/wide area network, cellular network or any other suitable wireless connection. The assistants may also communicate with each other over any suitable wired connection.

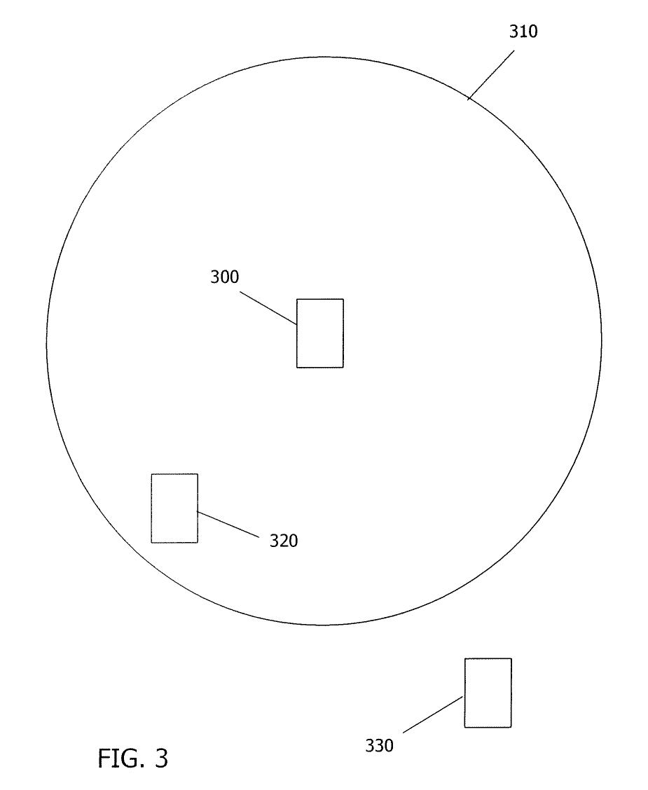

The assistants may be configured through any suitable settings menu to, for example, communicate with other assistants within a certain distance or range as can be best seen in FIG. 3. For example, the assistant in terminal 300 may be configured to search for other assistants that are within a predefined proximity 310 to the terminal 300. For example, the proximity 310 may be a one-mile radius from the current location of terminal 300. In other embodiments, any suitable range may be specified by a user. As can be seen in FIG. 3, the terminal 320 is within the proximity of the terminal 300 so that the assistant in terminal 300 may send a rumor message to the terminal 320. The terminal 330 is located outside the proximity 310 and will not receive the rumor message. In this example, the proximity is shown as having a circular shape but in other embodiments the proximity may have any suitable shape.

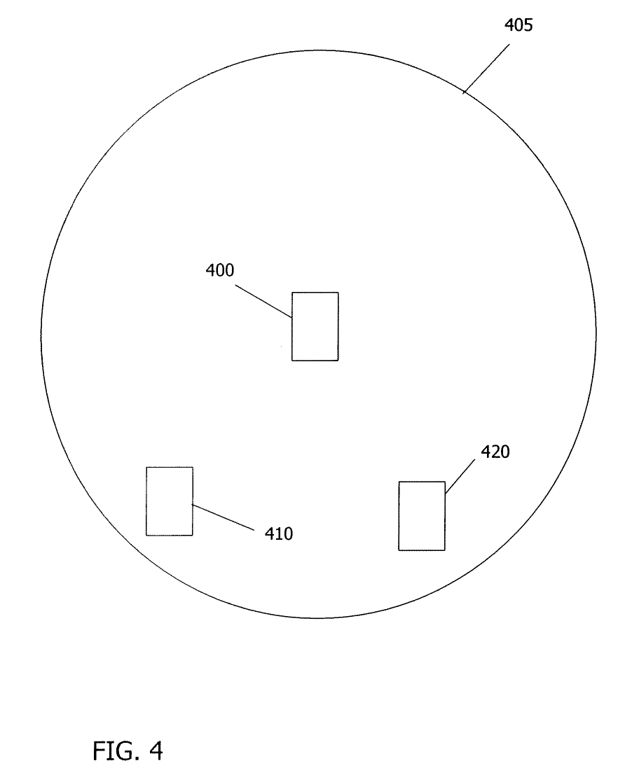

In other embodiments, there may be a limitless range (e.g. long range communication) assigned to the assistant through for example, communication over a cellular network or the internet. The user may be able to limit the long range communications of the assistant by specifying that only assistants in devices that are, for example, within the user's calling plan, can be contacted. In other embodiments the user may configure the assistant to contact other terminals within the cell the terminal is located. For example, as can be seen in FIG. 4, the terminal 400 is located within cell 405. The assistant in terminal 400 may be configured so that only other terminals 410, 420 within the cell 405 may be contacted for spreading a rumor.

In other embodiments, certain contacts or groups of contacts from the user's phone book can be selected so that the assistant interacts with the specified contacts. In alternate embodiments, the long range communication of the assistants can be limited in any suitable manner. In other embodiments the assistants may be proximity sensitive in that they may be configured to gossip more frequently with friends or contacts that are close by. The proximities of the terminals may be determined in any suitable manner. In one embodiment, the proximities may be determined through global positioning capabilities of the terminals. The terminal may broadcast their position to one another and when they are within a certain proximity the devices may communicate with each other as described herein. In other embodiments each of the terminals may broadcast any suitable signal which when received by another terminal triggers the communication described herein.

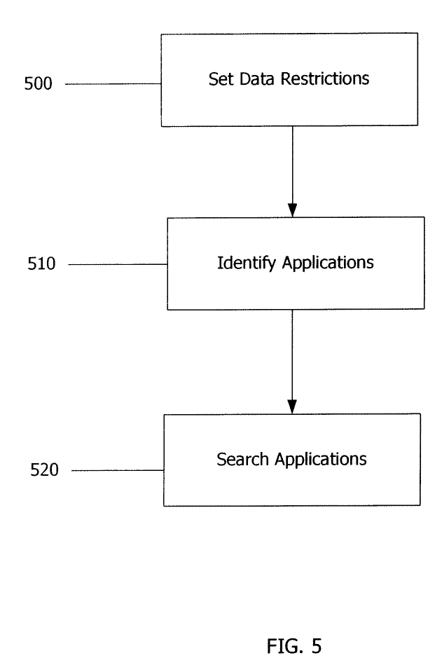

Referring again to FIG. 2 and to FIG. 5, the assistants 210, 230, 250, 270 may have any suitable settings that may be configured by a user through any suitable settings menu of the device. For example, the setting menu may include a privacy setting, a request setting, a request verification setting and the like. The information that can be searched, retrieved and combined the assistant may be un-secure, semi-secure or pre-designated information that is selected by the user as being available for the assistant. The privacy setting may, for example, allow the user to specify which bits of data within the device can be accessed by the assistants or allow for the user to turn off the assistant feature (FIG. 5, Block 500). For example, the assistant may be configured so that personal identification information is not accessible to the assistant to prevent identity theft or that the image gallery of the device is not to be used in generating a rumor. The user may also be able to specify which applications in the device the assistant has access to (FIG. 5, Block 510). For example the assistant may be configured to search through any suitable applications that may include but are not limited to appointment applications, calendar applications, a contacts applications, image galleries and the like while at the same time avoiding any restricted information (FIG. 5, Block 520). In alternate embodiments, any suitable information may be accessible or inaccessible to the assistants.

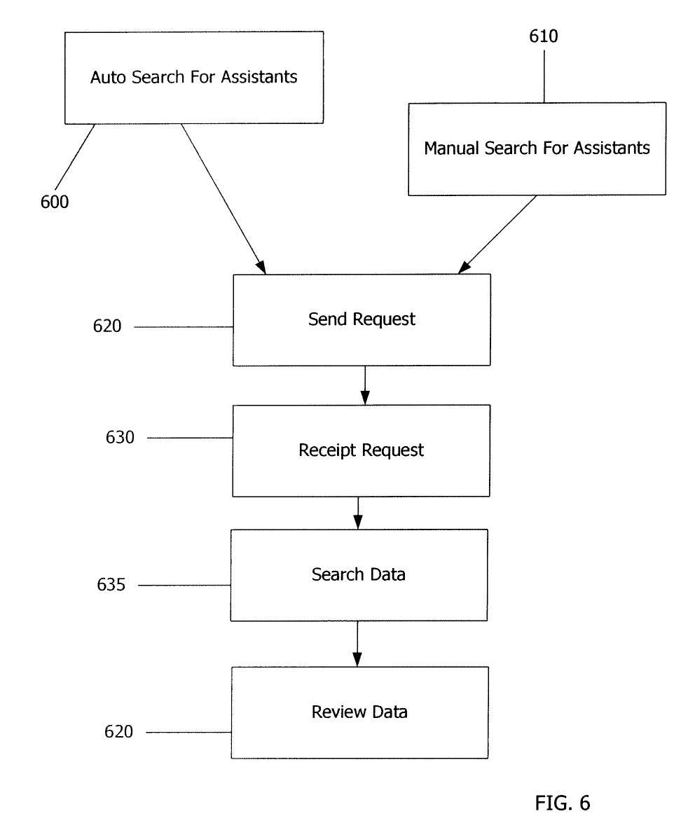

Referring now to FIG. 6, the request setting for example, may be configured so that the device 200 automatically searches for other assistants that want to start a rumor (FIG. 6, Block 600) or so that the user of the device 200 initiates the search for other assistants willing to gossip (FIG. 6, Block 610). The request verification may be set so that when a request for data is sent and/or received in the device 200, the user of the device 200 is prompted to either accept the request or deny the request (FIG. 6, Blocks 620 and 630). There may also be other settings such as, for example, a combined data review setting where the user can view the data gathered by the assistant of the user's device before that data is sent to other devices (FIG. 6, Block 640). There may also be a setting to specify a time of day when the device is to generate or receive rumors so as not to interrupt a user of the device during, for example, work, a meeting, while the user is sleeping, etc. The above settings are for exemplary purposes only and it is noted that any suitable settings can be applied to the embodiments described herein.

The assistants 210, 230, 250, 270 may be, for example, any suitable type of application that is capable of searching through a device and pulling data or information from that device (e.g. a “spider”). Any suitable search criteria, which may be user settable, may be applied by the assistant when, for example, the assistant is searching the device. The search criteria may include, but are not limited to any suitable criteria such as, for example, most recently changed entries, most recently updated entries, oldest or newest entries, user selected entries and the like. As an example, contextual data may be gathered in a manner described in commonly assigned U.S. patent application Ser. No. 11/026,663, entitled “Context Diary Application for a Mobile Terminal” filed on Dec. 31, 2004, in the name of inventors Younghee lung, Per Persson, Petri Piippo and Petri H. Maenpaa which is incorporated herein by reference in its entirety.

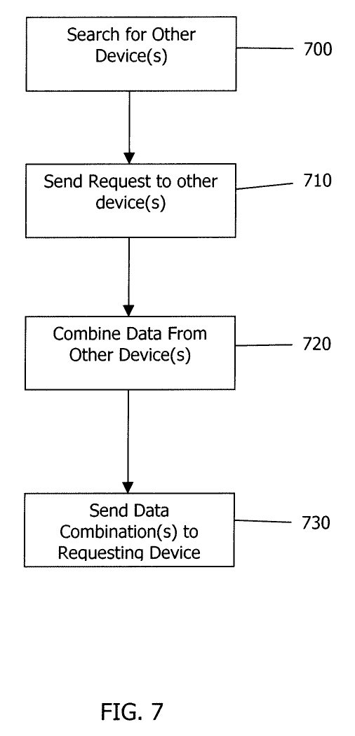

In one exemplary operation, of the assistant described herein, a first user may enter a room with device 200. The first user may have the assistant 210 in device 200 configured to automatically search for other assistants (FIG. 7, Block 700). In other embodiments the user may initiate communication with assistants in other devices through, for example, any suitable controls of the device 200. The assistant 210 may search for other assistants locally through short range communications or the assistant may search for other assistants through long range communications. In this example, the assistant searches for nearby devices that have assistants in them willing to gossip or spread rumors. For example, the assistant 210 may find device 220 and send a request to assistant 230. In other embodiments, the device assistant 210 may send requests to any number of assistants in other devices (FIG. 7, Block 710). The request may be a request for the combined data described above that creates a type of “rumor” for the user to discuss with other people or perhaps the user of the device 220.

In one example, the device 200 may prompt (i.e. the send request prompt) the user that a request is being sent to another device. The prompt may identify to the first user the device that the request is being sent to and ask the user if the request is to be sent (FIG. 6 , Block 620). In alternate embodiments, the send request prompt may include any suitable information. When the request is received by the device 220 the assistant 230 may prompt (i.e. the receive request prompt) the second user (i.e. the user of device 220) that a request for “rumor” has been received (FIG. 6, Block 630). The receive request prompt may identify to the second user the source of the request and ask the user whether or not the user will allow the request. In alternate embodiments, the receive request prompt may include any suitable information. In other embodiments, the request may be sent and received without prompting or notifying the users of the devices 200, 220 of the sending or receipt of the request.

The assistant 230 in response to the request may search any suitable information and/or applications in the device 220 including, but not limited to, calendar entries, notebook entries and the like (FIG. 6, Block 635). The assistant 230 may combine information from one or more sources of information from within device 220 (FIG. 7, Block 720). In this example one or more calendar entries are combined to create a rumor message. The rumor message may or may not be true and the pieces of information used to create the message may or may not have any connection with each other. The second user may be able to review the rumor message before the assistant 130 sends the message to the assistant 210 in device 200 (FIG. 6, Block 640). The message may be any suitable message including, but not limited to, email, SMS, MMS and the like. In alternate embodiments the messages may be converted to spoken messages through, for example, text recognition and speech synthesizers and sent to the receiving devices as voice messages. The first user may or may not know the second user and the message may or may not make sense to the first or second users. This message may be a form of entertainment or it may be used as an “ice breaker” to allow the first user to begin a conversation with the second user.

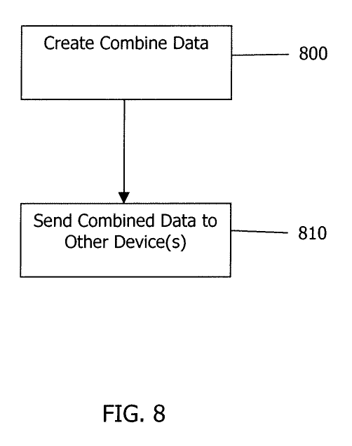

Referring to FIG. 8, in another exemplary operation of the disclosed embodiments, the device 200 may create a rumor message without a request from another device (FIG. 8, Block 800). The rumor message may be created automatically or by the first user prompting the device 200 to create the message. The assistant 210 of the device 200 may send the message to other devices configured to receive the message (FIG. 8, Block 810). The assistant 210 may be configured to send the message to any nearby device or the user of device 200 may be able to select the devices for receiving the message. For example, the device 200 may prompt the user of a list of available devices. Any suitable information may be presented to the user of device 200 with respect to the other devices. For example, the list of other devices may include, but not be limited to, user identification (e.g. name, what the user looks like, the user's gender, age, etc.). The first user may use this information to send the message to people he/she already knows or to people he/she would like to know.

In another exemplary operation of the disclosed embodiments the assistant 210 of device 200 (e.g. the first user) may tell a rumor to a friend or someone from the first user's contact list. The contacts for receiving the rumor may be selected by the first user in any suitable manner, such as in a settings menu or via a prompt before the rumor is sent. In alternate embodiments, there may be an “assistant contact list” for specifying a user's contact that are to receive rumor messages. As described above, the device 200 may receive a request for a rumor message or the device 200 may create a rumor message without receiving a request. The rumor may be sent to the contact(s) via any suitable communications network (e.g. long range or short range communications). Some example of message that may be created and sent by the assistant include “I heard Meoja is having her hair cut tomorrow, I wonder what she is planning!”; “When I told Erika's device assistant that you are going on a riding lesson this evening she told me in return that Erika went riding yesterday; and “Erika cancelled tomorrows riding lesson after Merda called her an hour ago. I wonder if they are planning something together for tomorrow!”

In other embodiments, the rumors generated by the assistant may pass from one device to another device. For example, device 200 sends a rumor to device 220. Device 220 then sends the same rumor to device 240. Device 240 may then send the rumor to device 260. The assistants may be configured to “twist” the rumors as they are passed from one device to the next as the rumors would be twisted when they are passed from one person to the next. For example, the rumor from device 200 to device 220 may be “Erika cancelled tomorrows riding lesson after Merda called her an hour ago. I wonder if they are planning something together for tomorrow!” The rumor from device 220 to device 240 may be “Erika cancelled tomorrows riding lesson after Medja called her an hour ago. They are going to the mall tomorrow!” The message from device 240 to device 260 may be “Erika and Medja are riding to the mall tomorrow!” In other embodiments the rumor may be twisted by the originating device so that the information conveyed is close to the original information but not quite correct. For example, the assistant might change the word “haircut” in a rumor message to the word “manicure” or the assistant might change the word “tomorrow” to “yesterday”.

In still other embodiments, a user of device 200, may for example request rumors from devices 220, 240, 260 to occupy some free time. In alternate embodiments a user may request rumors from other devices for any suitable reason.

The rumors from different devices may also be combined to form new rumors. For example a rumor from device 220 may read “Joe is buying a new car” while a rumor from device 240 may read “Steve is flying to Alaska”. These rumors may be combined in any suitable manner such as, for example by a service provider (e.g. cellular service provider, internet service provider, etc.) or by the assistant of the receiving device so that the device receiving the rumors gets the message “Joe is buying a new car in Alaska”.

The assistants may be configured to combine information from within the device with information obtained from an external source such as, for example, the internet. When a device receives a rumor request the assistant within the device may search, for example, any suitable web site such as a news website and combine information from the news website with information from within the device to create the rumor. In alternate embodiments any suitable external source may be searched, including by not limited to data cards and peripheral devices.

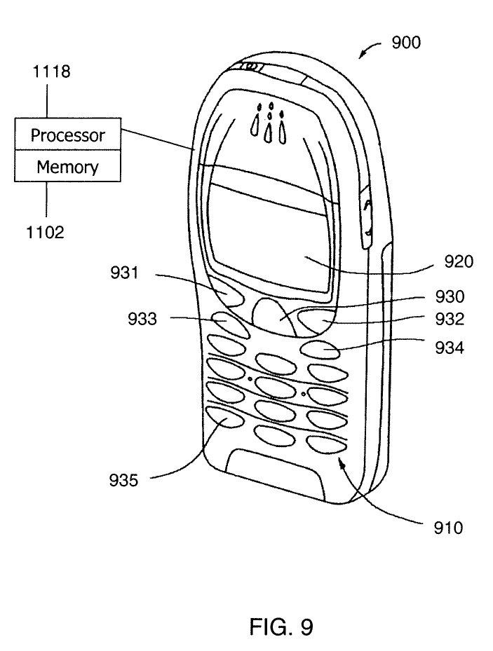

One embodiment of a device in which the disclosed embodiments may be employed is illustrated in FIG. 9. The terminal 900 may be any suitable device such as terminal or mobile communications device 200. The terminal 900 may have a keypad 910 and a display 920. The keypad 910 may include any suitable user input devices such as, for example, a multi-function/scroll key 930, soft keys 931, 932, a call key 933 and end call key 934 and alphanumeric keys 935. The display 920 may be any suitable display, such as for example, a touch screen display or graphical user interface. The display may be integral to the device 900 or the display may be a peripheral display connected to the device 900. A pointing device, such as for example, a stylus, pen or simply the user's finger may be used with the display 920. In alternate embodiments any suitable pointing device may be used. In other alternate embodiments, the display may be a conventional display. The device 900 may also include other suitable features such as, for example, a camera, loud speaker, connectivity port or tactile feedback features. The mobile communications device may have a processor 1118 connected to the display for processing user inputs and displaying information on the display 920. A memory 1102 may be connected to the processor 1118 for storing any suitable information and/or applications associated with the mobile communications device 900 such as phone book entries, calendar entries, web browsers, image galleries, videos, information logs, etc.

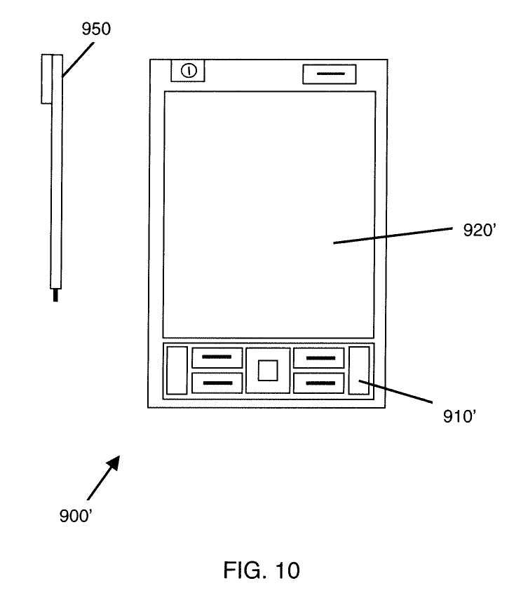

In one embodiment, the device, may be for example, a PDA style device 900′ as illustrated in FIG. 10. The PDA 900′ may have a keypad 910′, a touch screen display 920′ and a pointing device 950 for use on the touch screen display 920′. In still other alternate embodiments, the device may be a personal communicator, a tablet computer, a laptop or desktop computer, a television or television set top box or any other suitable device capable of containing the display 920 and supported electronics such as the processor 1118 and memory 1102.

FIG. 11 illustrates in block diagram form one embodiment of a general architecture of a mobile device that aspects of the disclosed embodiments may be employed. The mobile communications may have a processor 1118 connected to the display 1103 for processing user inputs and displaying information on the display 1103. The processor 1118 controls the operation of the device and can have an integrated digital signal processor 1117 and an integrated RAM 1115. The processor 1118 controls the communication with a cellular network via a transmitter/receiver circuit 1119 and an antenna 1120. A microphone 1106 is coupled to the processor 1118 via voltage regulators 1121 that transform the user's speech into analog signals. The analog signals formed are A/D converted in an A/D converter (not shown) before the speech is encoded in the DSP 1117 that is included in the processor 1118. The encoded speech signal is transferred to the processor 1118, which e.g. supports, for example, the GSM terminal software. The digital signal-processing unit 1117 speech-decodes the signal, which is transferred from the processor 1118 to the speaker 1105 via a D/A converter (not shown).

The voltage regulators 1121 form the interface for the speaker 1105, the microphone 1106, the LED drivers 1101 (for the LEDS backlighting the keypad 1107 and the display 1103), the SIM card 1122, battery 1124, the bottom connector 1127, the DC jack 1131 (for connecting to the charger 1133) and the audio amplifier 1132 that drives the (hands-free) loudspeaker 1125.

A processor 1118 can also include memory 1102 for storing any suitable information and/or applications associated with the mobile communications device such as phone book entries, calendar entries, etc.

The processor 1118 also forms the interface for peripheral units of the device, such as for example, a (Flash) ROM memory 1116, the graphical display 1103, the keypad 1107, a ringing tone selection unit 1126, an incoming call detection unit 1128 and a data collection unit 1140. In alternate embodiments, any suitable peripheral units for the device can be included.

The software in the RAM 1115 and/or in the flash ROM 1116 contains instructions for the processor 1118 to perform a plurality of different applications and functions such as, for example, those described herein.

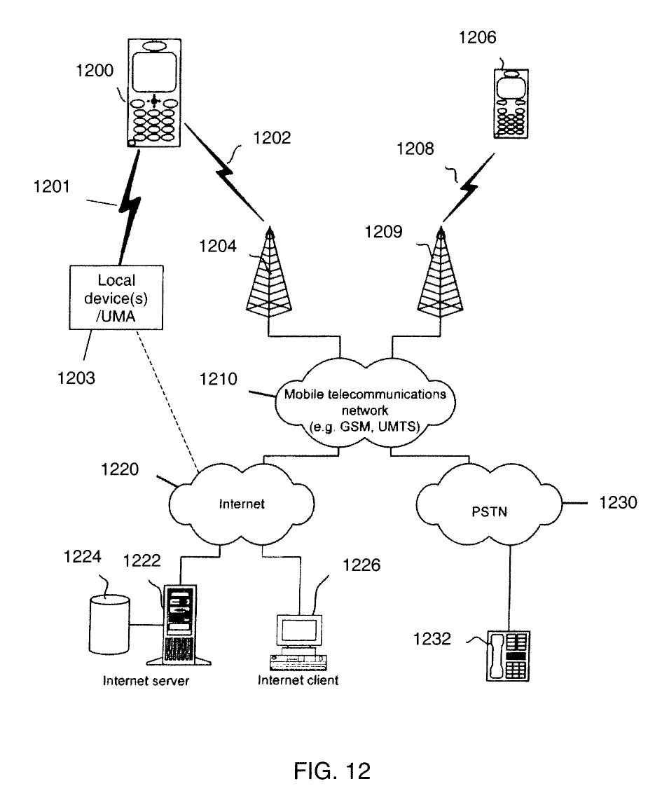

FIG. 12 is a schematic illustration of a cellular telecommunications system, as an example, of an environment in which a communications device 1200 incorporating features of an embodiment may be applied. Communication device 1200 may be substantially similar to that described above with respect to terminals 200. In the telecommunication system of FIG. 12, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 1200 and other devices, such as another mobile terminal 1206, a stationary telephone 1232, or an internet server 1222. It is to be noted that for different embodiments of the mobile terminal 1200 and in different situations, different ones of the telecommunications services referred to above may or may not be available. The aspects of the invention are not limited to any particular set of services in this respect.

The mobile terminals 1200, 1206 may be connected to a mobile telecommunications network 1210 through radio frequency (RF) links 1202, 1208 via base stations 1204, 1209. The mobile telecommunications network 1210 may be in compliance with any commercially available mobile telecommunications standard such as GSM, UMTS, D-AMPS, CDMA2000, FOMA and TD-SCDMA.

The mobile telecommunications network 1210 may be operatively connected to a wide area network 1220, which may be the internet or a part thereof. An internet server 1222 has data storage 1224 and is connected to the wide area network 1220, as is an internet client computer 1226. The server 1222 may host a www/hap server capable of serving www/hap content to the mobile terminal 1200.

For example, a public switched telephone network (PSTN) 1230 may be connected to the mobile telecommunications network 1210 in a familiar manner. Various telephone terminals, including the stationary telephone 1232, may be connected to the PSTN 1230.

The mobile terminal 1200 is also capable of communicating locally via a local link 1201 to one or more local devices 1203. The local link 1201 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 1203 can, for example, be various sensors that can communicate measurement values to the mobile terminal 1200 over the local link 1201. The above examples are not intended to be limiting, and any suitable type of link may be utilized. The local devices 1203 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the internet. The mobile terminal 1200 may thus have multi-radio capability for connecting wirelessly using mobile communications network 1210, WLAN or both. Communication with the mobile telecommunications network 1210 may also be implemented using WiFi, WiMax, or any other suitable protocols, and such communication may utilize unlicensed portions of the radio spectrum (e.g. unlicensed mobile access (UMA)).

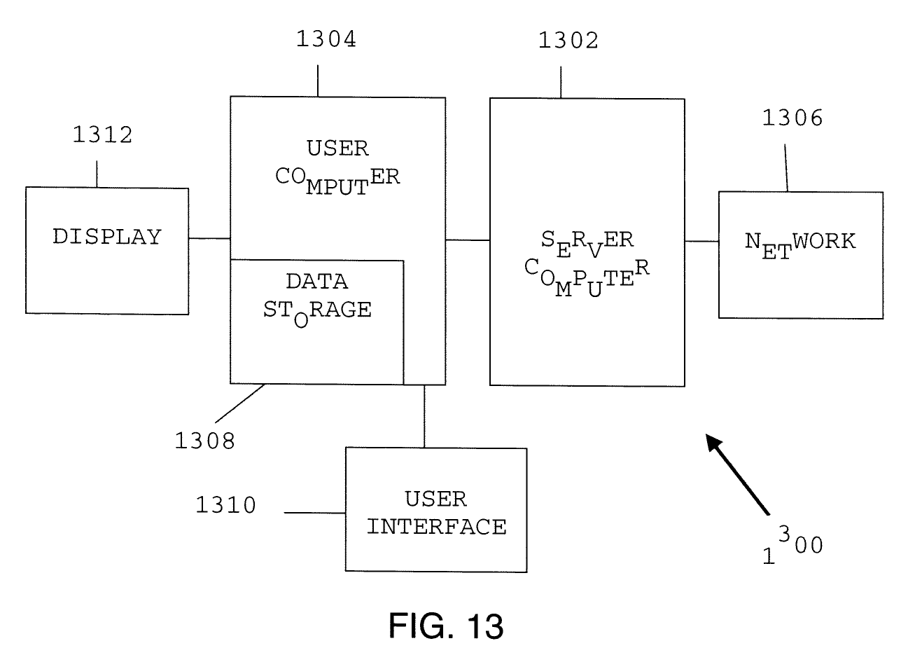

The disclosed embodiments may also include software and computer programs incorporating the process steps and instructions described herein that are executed in different computers. FIG. 13 is a block diagram of one embodiment of a typical apparatus 1300 incorporating features that may be used to practice aspects of the embodiments. As shown, a computer system 1302 may be linked to another computer system 1304, such that the computers 1302 and 1304 are capable of sending information to each other and receiving information from each other. In one embodiment, computer system 1302 could include a server computer adapted to communicate with a network 1306. Computer systems 1302 and 1304 can be linked together in any conventional manner including, for example, a modem, hard wire connection, or fiber optic link. Generally, information can be made available to both computer systems 1302 and 1304 using a communication protocol typically sent over a communication channel or through a dial-up connection on ISDN line. Computers 1302 and 1304 are generally adapted to utilize program storage devices embodying machine readable program source code which are adapted to cause the computers 1302 and 1304 to perform the method steps disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 1302 and 1304 may also include a microprocessor for executing stored programs. Computer 1302 may include a data storage device 1308 on its program storage device for the storage of information and data. The computer program or software incorporating the processes and method steps incorporating aspects of the invention may be stored in one or more computers 1302 and 1304 on an otherwise conventional program storage device. In one embodiment, computers 1302 and 1304 may include a user interface 1310, and a display interface 1312 from which aspects of the invention can be accessed. The user interface 1310 and the display interface 1312 can be adapted to allow the input of queries and commands to the system, as well as present the results of the commands and queries.

The disclosed embodiments may provide a user of the device with entertainment as well as provide a more human like interface or relationship between the device and its user. The disclosed embodiments also provide a user with a way to obtain information about others without taking any direct action with the other people. This leaves the user the option to contact the other people if the user so desires. Obtaining information about others through the device may also lead to an increased use of the device for contacting other people.

It should be understood that the foregoing description is only illustrative of the embodiments. Various alternatives and modifications can be devised by those skilled in the art without departing from the embodiments. Accordingly, the present embodiments are intended to embrace all such alternatives, modifications and variances that fall within the scope of the appended claims.

What is claimed is:

1. An apparatus comprising:
a data collection unit being configured to collect one or more pieces of data and combine at least a portion of each of the one or more pieces of data into a combined piece of data; and
a processor connected to the data collection unit configured to cause a transfer of the combined piece of data to at least one other device.

2. The apparatus of claim 1, wherein the combined piece of data is a misrepresentation of the one or more pieces of data.

3. The apparatus of claim 1, wherein the data collection unit is configured to collect the one or more pieces of data and combine them into the combined piece of data in response to a request for combined data.

4. The apparatus of claim 2, wherein the request for combined data is initiated by a user of the apparatus or another device.

5. The apparatus of claim 1, wherein the data collection unit is configured to search through at least one application of the device to obtain the one or more pieces of data.

6. The apparatus of claim 1, wherein the data collection unit is configured to search through an external source of information to obtain the one or more pieces of data.

7. The apparatus of claim 1, wherein the processor is configured to cause a transfer or a receipt of the combined data in dependence on the proximity of the at least one other device.

8. The apparatus of claim 1, wherein the processor is configured to cause the transfer or a receipt of combined data in dependence on a time of day.

9. The apparatus of claim 1, wherein the apparatus is a mobile communications device.

10. A method comprising:
combining at least a portion of one or more pieces of data of at least a first device into a combined data; and
sending the combined data to at least a second device.

11. The method of claim 10, wherein the combined data is a misrepresentation of the one or more pieces of data.

12. The method of claim 10, further comprising:
searching for at least the first device from the at least second device; and
sending a request for combined data from the at least second device to the at least first device.

13. The method of claim 10, wherein combining one or more pieces of data is performed in response to a request for combined data.

14. The method of claim 13, wherein the request for combined data is initiated by a user of the at least first device or a user of the at least second device.

15. The method of claim 10, wherein the one or more pieces of data are obtained from at least one application of the at least first device.

16. The method of claim 10, wherein the one or more pieces of data are obtained through a source of information external to the at least first device.

17. The method of claim 10, wherein the combined data is sent or received in dependence on the proximity of the at least one other device.

18. The method of claim 10, wherein the combined data is sent or received in dependence on a time of day.

19. A computer program product comprising:
a computer useable medium having computer readable code means embodied therein for causing a computer combine at least a portion of one or more pieces of data, the computer readable code means in the computer program product comprising:
computer readable program code means for causing a computer to combine a portion of each of the one or more pieces of data of at least a first device into a combined data; and
computer readable code means for causing a computer to send the combined data to at least a second device.

20. The computer program product of claim 19, further comprising:
computer readable program code means for causing a computer to search for at least the first device from the at least second device; and
computer readable program code means for causing a computer to send a request for combined data from the at least second device to the at least first device.

21. The computer program product of claim 19, wherein combining the one or more pieces of data is performed in response to a request for combined data.

22. The computer program product of claim 21, wherein the request for combined data is initiated by a user of the at least first device or a user of the at least second device.
